(19) United States
(12) Patent Application Publication
(10) Pub. No.: US 2023/0362622 A1
(43) Pub. Date: Nov. 9, 2023

(54) METHOD AND DEVICE FOR NETWORK EXPOSURE FOR GROUP

(71) Applicant: Samsung Electronics Co., Ltd., Suwon-si (KR)

(72) Inventor: Sangjun MOON, Suwon-si (KR)

(21) Appl. No.: 18/311,804

(22) Filed: May 3, 2023

(30) Foreign Application Priority Data
May 4, 2022 (KR) 10-2022-0055500

(51) Int. Cl. H04W 8/18

(52) U.S. Cl. CPC H04W 8/186

(57) ABSTRACT

The present disclosure relates to a 5G or 6G communication system for supporting a higher data transmission rate. According to an embodiment, a method for operating an NEF in a wireless communication system comprises receiving a request message including an external group ID and an aggregation condition used outside a network, from an AF, converting the external group ID into an internal group ID used inside the network, performing aggregation on a response or reporting based on the aggregation condition and the internal group ID, and transmitting a response message corresponding to the request message to the AF. The aggregation condition may include a first condition for data transmission and a second condition for an event.

### CROSS-REFERENCE TO RELATED APPLICATION

This application is based on and claims priority under 35 U.S.C. § 119 to Korean Patent Application No. 10-2022-0055500, which was filed in the Korean Intellectual Property Office on May 4, 2022, the entire disclosure of which is incorporated herein by reference.

### BACKGROUND

### 1. Field

The present disclosure relates to a method for supporting provisioning and monitoring for a user equipment (UE) and traffic, targeting a group, by extending the capability of supporting group communication in a wireless communication network.

### 2. Description of Related Art

5^{th} generation (5G) mobile communication technology defines a wide frequency band to enable fast transmission speed and new services and may be implemented in frequencies below 6 GHz (“sub 6 GHz”), such as 3.5 GHz, as well as in ultra-high frequency bands (“above 6 GHz”), such as 28 GHz and 39 GHz called millimeter wave (mmWave). Further, 6G mobile communication technology, which is called a beyond 5G system, is considered to be implemented in terahertz bands (e.g., 95 GHz to 3 THz) to achieve a transmission speed 50 times faster than 5G mobile communication technology and ultra-low latency reduced by ⅒.

In the early stage of 5G mobile communication technology, standardization was conducted on beamforming and massive MIMO for mitigating propagation pathloss and increasing propagation distance in ultrahigh frequency bands, support for various numerologies for efficient use of ultrahigh frequency resources (e.g., operation of multiple subcarrier gaps), dynamic operation of slot format, initial access technology for supporting multi-beam transmission and broadband, definition and operation of bandwidth part (BWP), new channel coding, such as low density parity check (LDPC) code for massive data transmission and polar code for high-reliable transmission of control information, L2 pre-processing, and network slicing for providing a dedicated network specified for a specific service, so as to meet performance requirements and support services for enhanced mobile broadband (eMBB), ultra-reliable low-latency communications (URLLC), and massive machine-type communications (mMTC).

Currently, improvement and performance enhancement in the initial 5G mobile communication technology is being discussed considering the services that 5G mobile communication technology has intended to support, and physical layer standardization is underway for technology, such as vehicle-to-everything (V2X) for increasing user convenience and assisting autonomous vehicles in driving decisions based on the position and state information transmitted from the VoNR, new radio unlicensed (NR-U) aiming at the system operation matching various regulatory requirements, NR UE power saving, non-terrestrial network (NTN) which is direct communication between UE and satellite to secure coverage in areas where communications with a terrestrial network is impossible, and positioning technology.

Also being standardized are radio interface architecture/protocols for technology of industrial Internet of things (IIoT) for supporting new services through association and fusion with other industries, integrated access and backhaul (IAB) for providing nodes for extending the network service area by supporting an access link with the radio backhaul link, mobility enhancement including conditional handover and dual active protocol stack (DAPS) handover, 2-step RACH for NR to simplify the random access process, as well as system architecture/service fields for 5G baseline architecture (e.g., service based architecture or service based interface) for combining network functions virtualization (NFV) and software-defined networking (SDN) technology and mobile edge computing (MEC) for receiving services based on the position of the UE.

As 5G mobile communication systems are commercialized, soaring connected devices would be connected to communication networks so that reinforcement of the function and performance of the 5G mobile communication system and integrated operation of connected devices are expected to be needed. To that end, new research is to be conducted on, e.g., extended reality (XR) for efficiently supporting, e.g., augmented reality (AR), virtual reality (VR), and mixed reality (MR), and 5G performance enhancement and complexity reduction using artificial intelligence (AI) and machine learning (ML), support for AI services, support for metaverse services, and drone communications.

Further, development of such 5G mobile communication systems may be a basis for multi-antenna transmission technology, such as new waveform for ensuring coverage in 6G mobile communication terahertz bands, full dimensional MIMO (FD-MIMO), array antenna, and large scale antenna, full duplex technology for enhancing the system network and frequency efficiency of 6G mobile communication technology as well as reconfigurable intelligent surface (RIS), high-dimensional space multiplexing using orbital angular momentum (OAM), metamaterial-based lens and antennas to enhance the coverage of terahertz band signals, AI-based communication technology for realizing system optimization by embedding end-to-end AI supporting function and using satellite and artificial intelligence (AI) from the step of design, and next-generation distributed computing technology for implementing services with complexity beyond the limit of the UE operation capability by way of ultrahigh performance communication and computing resources.

### SUMMARY

The present disclosure supports a network exposure method for changing UE and traffic configurations or monitoring a specific event or performance at the request of an external application function (AF) of a 3GPP network (e.g., 5GS).

The present disclosure also supports a method for creating/changing/deleting a group and adding/changing/deleting a group member to support group communication in a 3GPP network (e.g., 5GS).

The present disclosure requires additional considerations on how to cope with a group change and how to aggregate responses to a group, as compared with handling one UE when network exposure is supported for a group.

According to an embodiment, a method for operating a network exposure function (NEF) in a wireless communication system may comprise receiving a request message including an external group identity (ID) and an aggregation condition used outside a network, from an application function (AF), converting the external group ID into an internal group ID used inside the network, performing aggregation on a response or reporting based on the aggregation condition and the internal group ID, and transmitting a response message corresponding to the request message to the AF. The aggregation condition may include a first condition for data transmission and a second condition for an event.

According to an embodiment, a method for operating an application function (AF) in a wireless communication system may comprise transmitting a request message including an external group ID and an aggregation condition used outside a network, to a network exposure function (NEF) and receiving a response message corresponding to the request message from the NEF. The external group ID may be converted into an internal group ID used inside the network. Aggregation on a response or reporting may be performed based on the aggregation condition and the internal group ID. The aggregation condition may include a first condition for data transmission and a second condition for an event.

According to an embodiment, a network exposure function (NEF) in a wireless communication system comprises a transceiver and a processor. The processor may be configured to control to receive a request message including an external group identity (ID) and an aggregation condition used outside a network, from an application function (AF), convert the external group ID into an internal group ID used inside the network, perform aggregation on a response or reporting based on the aggregation condition and the internal group ID, and control to transmit a response message corresponding to the request message to the AF. The aggregation condition may include a first condition for data transmission and a second condition for an event.

According to an embodiment, an application function (AF) in a wireless communication system comprises a transceiver and a processor. The processor may be configured to control to transmit a request message including an external group ID and an aggregation condition used outside a network, to a network exposure function (NEF) and control to receive a response message corresponding to the request message from the NEF. The external group ID may be converted into an internal group ID used inside the network. Aggregation on a response or reporting may be performed based on the aggregation condition and the internal group ID. The aggregation condition may include a first condition for data transmission and a second condition for an event.

The present disclosure may support a network exposure method for changing UE and traffic configurations or monitoring a specific event or performance at the request of an external application function (AF) in a 3GPP network (e.g., 5GS).

The present disclosure may specify aggregation conditions when a change occurs in a group, supporting detailed operations.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 illustrates group management and network exposure according to an embodiment of the present disclosure;

FIG. 2 illustrates a flowchart illustrating operations of a group network exposure method according to an embodiment of the present disclosure;

FIG. 3 illustrates an aggregation condition according to an embodiment of the present disclosure;

FIGS. 4A and 4B illustrate flowcharts illustrating a group provisioning method according to an embodiment of the present disclosure;

FIGS. 5A and 5B illustrate flowcharts illustrating a group monitoring method according to an embodiment of the present disclosure;

FIG. 6 illustrates a configuration of a UE according to an embodiment of the present disclosure; and

FIG. 7 illustrates a configuration of a network entity according to an embodiment of the present disclosure.

### DETAILED DESCRIPTION

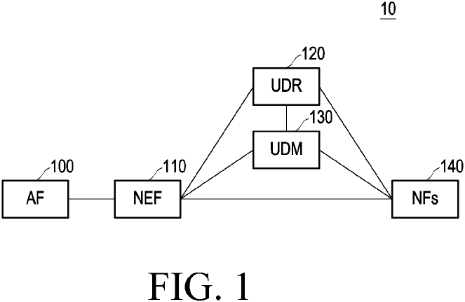

FIGS. 1 through 7, discussed below, and the various embodiments used to describe the principles of the present disclosure in this patent document are by way of illustration only and should not be construed in any way to limit the scope of the present disclosure. Those skilled in the art will understand that the principles of the present disclosure may be implemented in any suitably arranged system or device.

Hereinafter, the operational principle of the present disclosure is described below with reference to the accompanying drawings. When determined to make the subject matter of the present disclosure unclear, the detailed description of known functions or configurations may be skipped. The terms as used herein are defined considering the functions in the present disclosure and may be replaced with other terms according to the intention or practice of the user or operator. Therefore, the terms should be defined based on the overall disclosure.

As used herein, terms for identifying access nodes, terms denoting network entities, terms denoting messages, terms denoting inter-network entity interfaces, and terms denoting various pieces of identification information are provided as an example for ease of description. Thus, the present disclosure is not limited by the terms, and such terms may be replaced with other terms denoting objects with equivalent technical concept.

For ease of description, the terms and names defined in the 3rd generation partnership project 5G and NR standards among communication standards are used herein. However, the present disclosure is not limited by such terms and names and may be likewise applicable to wireless communication networks conforming to other standards. In particular, the present disclosure may be applied to 3GPP GS/NR (e.g., 5th generation mobile communication standards).

FIG. 1 illustrates group management and network exposure according to an embodiment of the present disclosure.

Referring to FIG. 1, a wireless communication system 10 may include an application function (AF) 100, a network exposure function (NEF) 110, a unified data repository (UDR) 120, a unified data management (UDM) 130, and a plurality of network exposure functions (NFs) 140.

The AF 100 may be a network entity having the function of providing services to users in conjunction with a mobile communication network.

The NEF 110 may be a network entity that may gain access to information for managing the UE in the 5G network and may transmit subscription to mobility management events for the UE, subscription to session management events for the UE, a request for session-related information, billing information configuration for the UE, a PDU session policy change request for the UE, and small data for the UE.

The UDR 120 may be a network entity that stores and manages data. The UDR 120 may store UE subscription information and provide the UE subscription information to the UDM 130 when a new UE is enrolled, or a change to the existing UE subscription information is made or requested. The UDR 120 may store operator policy information and may provide operator policy information. The UDR 120 may store network service exposure-related information and provide the network service exposure-related information to the NEF 110.

The UDM 130 may be a network entity that stores information about subscribers and/or UEs.

Each of the plurality of NFs 140 may be one network node. One network node may be physically or/and logically independent or may be configured with other specific nodes. Each of the plurality of NFs 140 may be implemented as a specific device. As another example, each of the plurality of NFs 140 may be implemented as a combination of a device and software. As another example, each of the plurality of NFs 140 may be implemented as software in a device on a collective specific network. According to an embodiment, each of the plurality of NFs 140 may be a specific instance, and two or more identical or different instances may be operated in one device. Even if driven in the form of such an instance, it may be understood in the same manner applied to the NFs described in the present disclosure.

According to an embodiment, the AF 100 may configure a group in the UDR 120 via the NEF 110. According to an embodiment, groups may be created, modified, and/or deleted. Members may be added and/or deleted for each group, and attributes may also be set for each group.

According to another embodiment, the AF 100 may change the UE and traffic configurations in conjunction with the NFs 140 in the 5GS via the NEF 110 or monitor a specific event or performance of the UE and traffic.

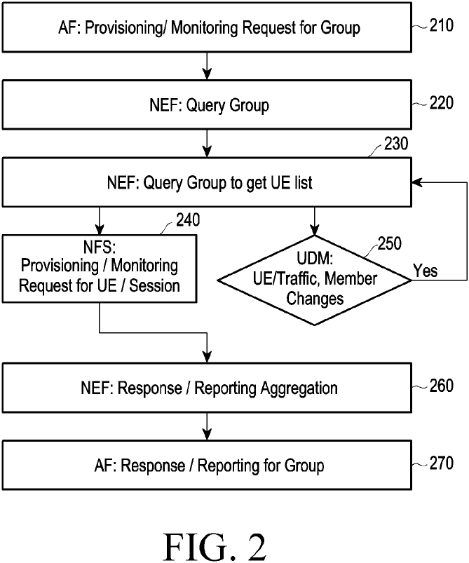

FIG. 2 illustrates a flowchart illustrating operations of a group network exposure method according to an embodiment of the present disclosure.

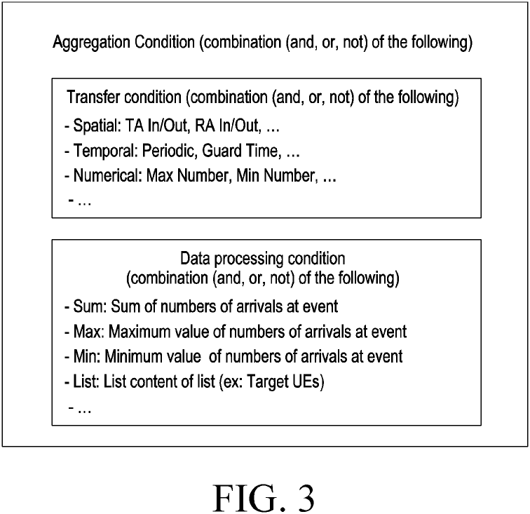

Referring to FIGS. 1 and 2, in step 210, the AF 100 may send a provisioning and/or monitoring request for the group to the NEF 110. According to an embodiment, the provisioning and/or monitoring request may include information about an aggregation condition. The aggregation condition is described below in detail in connection with FIG. 3.

In step 220, the NEF 110 may query the UDR 120 and/or the UDM 130 for information about the group. In step 230, the NEF 110 may obtain a list of groups from the UDR 120 and/or the UDM 130. The NEF 110 may identify the list of groups and request the necessary NFs 140 for provisioning/monitoring.

In step 240, at least one of the plurality of NFs 140 may transmit a provisioning and/or monitoring request for a UE/session.

The NEF 110 may request them to notify of a change in the UE/session of group and a member change and, if any change, request the necessary NFs 140 for provisioning/monitoring for each UE.

In step 250, the UDM 130 may transmit information about the UE, traffic, and/or member change to the NEF 110 when there is a UE, traffic, and/or member change. Thereafter, in step 230, the NEF 110 may obtain a list of groups from the UDR 120 and/or the UDM 130.

In step 260, the NEF 110 may process provisioning/monitoring response and reporting according to aggregation conditions. The NEF 110 may transfer the result processed in step 260 to the AF 100. In step 270, the AF 100 may identify response and reporting for the group.

FIG. 3 illustrates an aggregation condition according to an embodiment of the present disclosure.

Referring to FIG. 3, aggregation conditions may include transfer conditions and data processing (or collection) conditions.

The transfer conditions may be configured in the following combination:
Per Group, Per UE;
Spatial: tracking area (TA) in/out, registration area (RA) on/out;
Time: Periodic: Sends at regular time intervals, Guard Time: Sends after a predetermined time; or
Number of events: Max Number: Sends when this number is reached, Min Number: Sends after this number is reached, etc.

Data processing (or collection) conditions may be set in the following combination:
Per Group, Per UE;
Sum: Sum of the number of arrivals at the event (e.g., UEs newly entering a specific TA area);
Max: Take the maximum value of arrivals at the event (ex: Peak data rate); or
List: Lists event contents (e.g., Target UEs) etc.

According to an embodiment, the aggregation conditions may process request/response transfer in combination of the transfer condition and the data processing (or collection) condition.

For example, the transfer condition and data processing (or collection) condition may be combined as follows:
Transfer condition: Per Group, Periodic, data processing (or collection) condition: Per Group Sum; or
Transfer condition: Per Group Guard Time & Max Number & Min Number, data processing (or collection) condition: Per Group, List UE, etc.

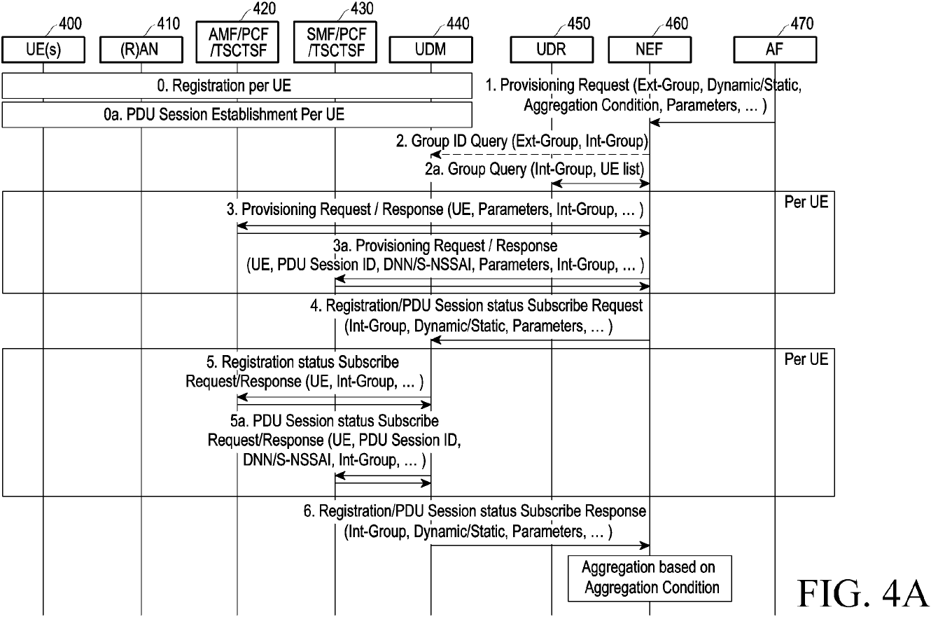

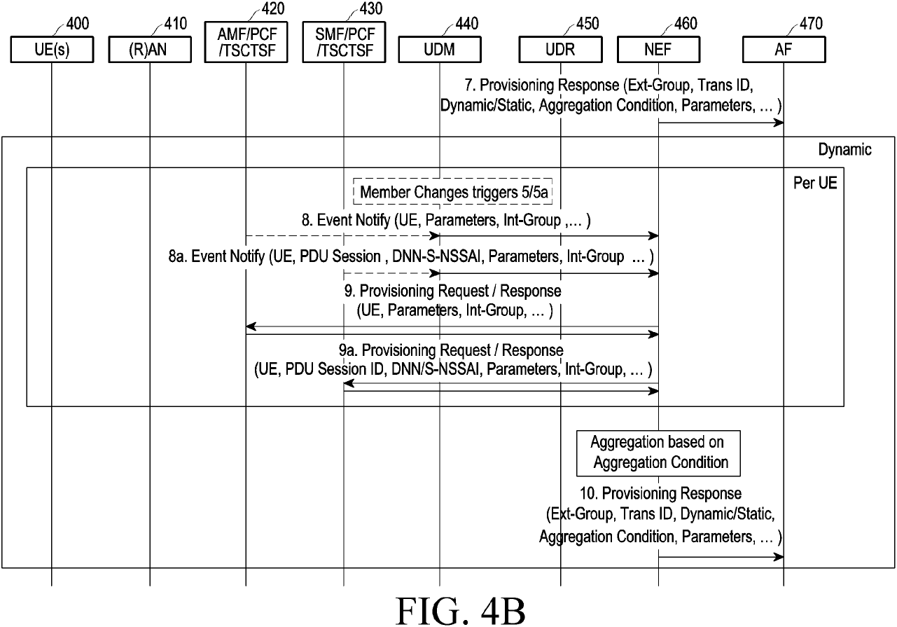

FIGS. 4A and 4B illustrate a group provisioning method according to an embodiment of the present disclosure.

Referring to FIGS. 4A and 4B, a wireless communication system for group provisioning may include a user equipment (UE) 400, an (R)AN 410, an AMF/PCF/TSCTSF 420, an SMF/PCF/TSCTSF 430, a UDM 440, a UDR 450, an NEF 460, and an AF 470. Here, AMF may be an access and mobility management function, SMF may be a session management function, PCF may be a policy control function, and TSCTSF may be a time sensitive communication and time synchronization function.

In step 0, the UE 400 may perform a registration procedure with the 5GS.

In step 0a, the UE 400 may establish a PDU session with the 5GS.

In step 1, the AF 470 may send a provisioning request to the NEF 460. According to an embodiment, the provisioning request may include at least one of external-group ID (Ext-Group), dynamic/static Indication, aggregation condition, and other parameters.

According to an embodiment, the external group ID may be a group ID used outside the 5G system.

According to an embodiment, when set to Dynamic, the provisioning request may be additionally applied according to a changed situation when a member change occurs in the future. According to an embodiment, when set to Static, the provisioning request targets the members as of the time of the request and may not consider further reflection for additional members if a member change occurs in the future.

According to an embodiment, the aggregation conditions are as shown in FIG. 3.

In step 2, the NEF 460 may convert the external group ID received in step 1 into an internal group ID used inside the 3GPP network. According to an embodiment, the NEF 460 may query the UDM 440 based on the external group ID and, in response, receive the internal group ID.

In step 2a, the NEF 460 may perform a group query to the UDR 450 to obtain a UE list corresponding to the internal group ID.

In step 3, the NEF 460 may request the configuration related to the UE 400 from the network functions (NFs) of the AMF, PCF, and TSCTSF for each UE identified in step 2a and receive responses for the configured result. According to an embodiment, the request and response messages may include at least one of a UE ID, an internal group ID, and configuration-related parameters.

In step 3a, the NEF 460 may request configuration related to traffic from the NFs of the SMF, PCF, and TSCTSF for each UE identified in step 2a, and may receive a response for the configured result. According to an embodiment, the request and response messages may include at least one of the UE ID, the PDU session ID, the data network name (DNN)/single network slice selection assistance information (S-NSSAI), the internal group ID, and configuration-related parameters.

In step 4, the NEF 460 may send a registration/PDU session status subscribe request to the UDM 440. According to an embodiment, the registration/PDU session status subscribe request may include at least one of the internal group ID, dynamic/static indication, and other parameters.

In step 5, the UDM 440 may send a request for registration status subscribe to the AMF 420 for each UE in the group specified by the internal group ID and receive a response. According to an embodiment, the request/response of the registration status subscribe may include at least one of the UE ID and the internal group ID.

In step 5a, the UDM 440 may send a PDU session status subscribe request to the SMF 430 for each UE in the group specified by the internal group ID, and receive a response. According to an embodiment, the request/response of the PDU session status subscribe may include at least one of the UE ID, the internal group ID, the PDU session ID, and the DNN/S-NSSAI.

In step 6, the UDM 440 may send a registration/PDU session status subscribe response to the NEF 460. According to an embodiment, the registration/PDU session status subscribe response may include at least one of the internal group ID, dynamic/static indication, and other parameters.

The NEF 460 may perform aggregation based on the aggregation condition.

In step 7, the NEF 460 may aggregate responses according to the data processing (or collection) condition of the aggregation condition and may transmit a provisioning response to the AF 470 based on the transfer condition of the aggregation condition. According to an embodiment, the provisioning response may include at least one of External-Group ID, transaction ID, dynamic/static Indication, and aggregation condition. According to an embodiment, the provisioning response may be for a group and may be a collection of responses for each individual UE. According to an embodiment, the provisioning response is for monitoring for each UE, and may be a collection of several responses for individual UEs.

In step 8, if a change in the registration status of the UE 400 occurs, the AMF 420 may notify the UDM 440, which in turn may notify the NEF 460. According to an embodiment, the notification may include at least one of the UE ID and the internal group ID. According to an embodiment, if the AF 470 is set to Dynamic in step 1 and a member change occurs, UDM 440 may perform steps 5 and 5a in relation to the changed UE.

In step 8a, if a change in the PDU session status of the UE 400 occurs, the SMF 430 may notify the UDM 440, which in turn may notify the NEF 460. According to an embodiment, the notification may include at least one of the UE ID, session ID, DNN/S-NSSAI, and the internal group ID. According to an embodiment, if the AF 470 is set to Dynamic in step 1 and a member change occurs, UDM 440 may perform steps 5 and 5a in relation to the changed UE.

In step 9, the NEF 460 may request the configuration related to the UE 400 from the network functions (NFs) of the AMF, PCF, and TSCTSF for each UE identified in step 8 and receive responses for the configured result. According to an embodiment, the request and response messages may include at least one of a UE ID, an internal group ID, and configuration-related parameters.

In step 9a, the NEF 460 may request configuration related to traffic from the NFs of the SMF, PCF, and TSCTSF for each UE identified in step 8a, and may receive a response for the configured result. According to an embodiment, the request and response messages may include at least one of the UE ID, the PDU session ID, the data network name (DNN)/single network slice selection assistance information (S-NSSAI), the internal group ID, and configuration-related parameters.

The NEF 460 may perform aggregation based on the aggregation condition.

In step 10, the NEF 460 may aggregate responses according to the data processing (or collection) condition of the aggregation condition and may transmit a provisioning response to the AF 470 based on the transfer condition of the aggregation condition. According to an embodiment, the provisioning response may include at least one of External-Group ID, transaction ID, dynamic/static Indication, and aggregation condition. According to an embodiment, the provisioning response may be for a group and may be a collection of responses for each individual UE. According to an embodiment, the provisioning response is for monitoring for each UE, and may be a collection of several responses for individual UEs.

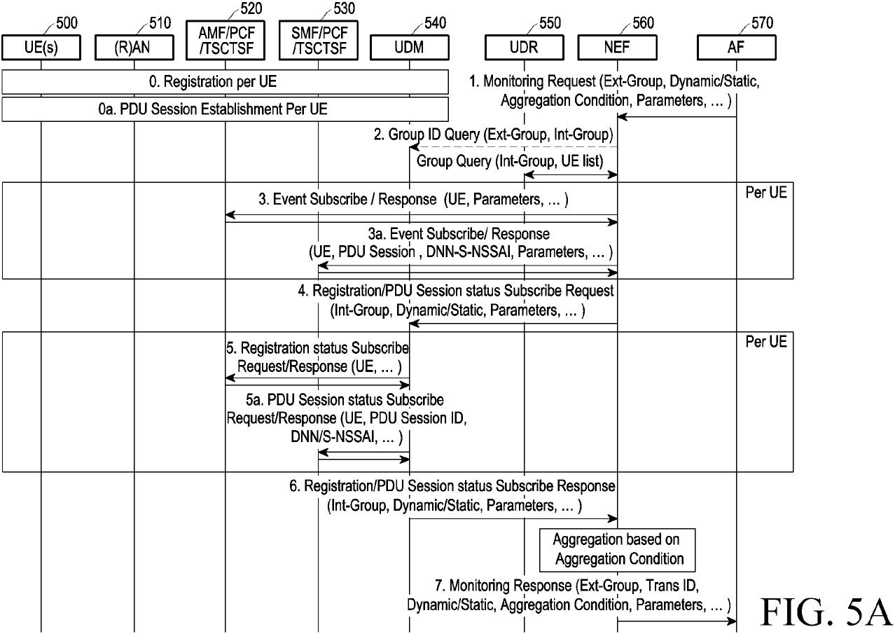

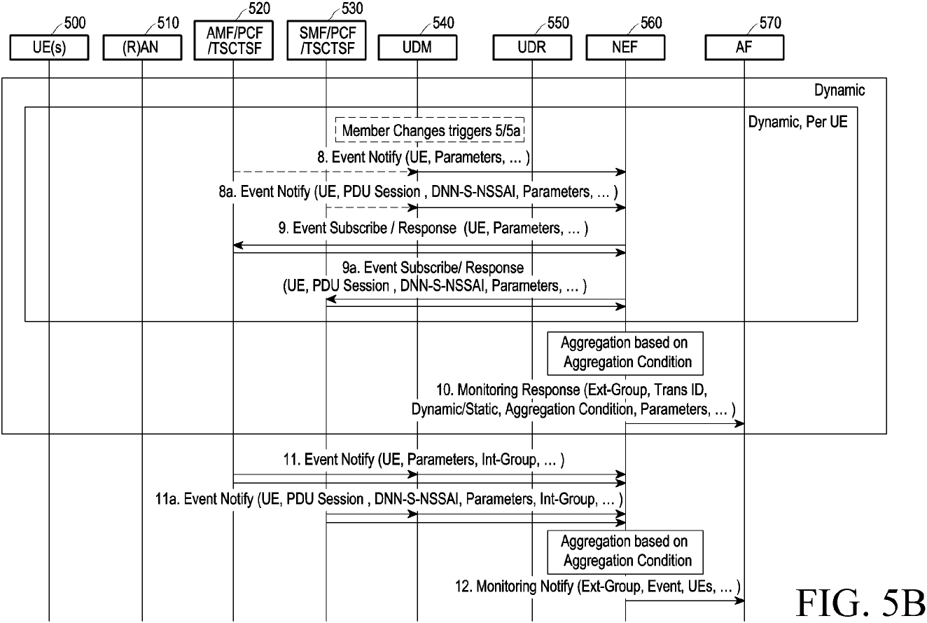

FIGS. 5A and 5B illustrate flowcharts illustrating a group monitoring method according to an embodiment of the present disclosure.

Referring to FIGS. 5A and 5B, a wireless communication system for group monitoring may include a user equipment (UE) 500, an (R)AN 510, an AMF/PCF/TSCTSF 520, an SMF/PCF/TSCTSF 530, a UDM 540, a UDR 550, an NEF 560, and an AF 570.

In step 0, the UE 500 may perform a registration procedure with the 5GS.

In step 0a, the UE 500 may establish a PDU session with the 5GS.

In step 1, the AF 570 may send a monitoring request to the NEF 560. According to an embodiment, the monitoring request may include at least one of External-Group ID (Ext-Group), dynamic/static Indication, aggregation condition, and other parameters.

According to an embodiment, the External Group ID (Ext-Group) may be a group ID used outside the 5G system.

According to an embodiment, when set to Dynamic, the corresponding configuration may be applied to the changed member when the member change occurs. According to an embodiment, when set to Static, the corresponding configuration targets the members as of the time of the request, and the configuration may not be reflected for additional members if a member change occurs in the future.

According to an embodiment, the aggregation conditions are as described above in connection with FIG. 3.

In step 2, the NEF 560 may convert the external group ID received in step 1 into an internal group ID (Int-Group) used inside the 3GPP network. According to an embodiment, the NEF 560 may query the UDM 540 based on the external group ID and, in response, receive the internal group ID.

In step 2a, the NEF 560 may perform a group query to the UDR 550 to receive a UE list corresponding to the internal group ID.

In step 3 or 3a, the NEF 560 may request the configuration related to traffic, for event subscription, from the network functions (NFs) of the SMF, PCF, and/or TSCTSF for each UE identified in step 2a and receive a response thereto.

According to an embodiment, the event subscribe request and response messages may include at least one of the UE ID, the PDU session ID, the data network name (DNN)/single network slice selection assistance information (S-NSSAI), the internal group ID, and configuration-related parameters.

In step 4, the NEF 560 may send a registration/PDU session status subscribe request to the UDM 540. According to an embodiment, the registration/PDU session status subscribe request may include at least one of the internal group ID, dynamic/static indication, and other parameters.

In step 5, the UDM 540 may send a request for registration status subscribe to the AMF 520 for each UE in the group specified by the internal group ID. The UDM 540 may receive a response to the registration status subscribe request. According to an embodiment, the request/response of the registration status subscribe may include at least one of the UE ID and the internal group ID.

In step 5a, the UDM 540 may send a request for PDU session status subscribe to the SMF 530 for each UE in the group specified by the internal group ID. The UDM 540 may receive a response to the PDU session status subscribe request. According to an embodiment, the request/response of the PDU session status subscribe may include at least one of the UE ID, the internal group ID, the PDU session ID, and the DNN/S-NSSAI.

In step 6, the UDM 540 may send a registration/PDU session status subscribe response to the NEF 560. According to an embodiment, the registration/PDU session status subscribe response may include at least one of the internal group ID, dynamic/static indication, and other parameters.

The NEF 560 may perform aggregation based on the aggregation condition.

In step 7, the NEF 560 may aggregate responses according to the data processing (or collection) condition of the aggregation condition and may transmit a monitoring response to the AF 570 considering the transfer condition of the aggregation condition. According to an embodiment, the monitoring response may include at least one of External-Group ID, transaction ID, dynamic/static Indication, and aggregation condition. According to an embodiment, the monitoring response may be for a group and may be a collection of responses for each individual UE. According to an embodiment, the monitoring response is for monitoring for each UE, and may be a collection of several responses for individual UEs.

In step 8, if a change in the registration status of the UE 500 occurs, the AMF 520 may notify the UDM 540, which in turn may notify the NEF 560. According to an embodiment, the notification may include at least one of the UE ID and the internal group ID. According to an embodiment, if the AF 570 is set to Dynamic in step 1 and a member change occurs, UDM 540 may perform steps 5 and 5a in relation to the changed UE.

In step 8a, if a change in the PDU session status of the UE 500 occurs, the SMF 530 may notify the UDM 540, which in turn may notify the NEF 560. According to an embodiment, the notification may include at least one of the UE ID, session ID, DNN/S-NSSAI, and the internal group ID. According to an embodiment, if the AF 570 is set to Dynamic in step 1 and a member change occurs, UDM 540 performs steps 5 and 5a in relation to the changed UE.

In step 9, the NEF 560 may request the configuration related to the UE 500, for monitoring, from the network functions (NFs) of the AMF, PCF, and TSCTSF for each UE identified in step 8 and receive a response thereto. According to an embodiment, the request and response messages may include at least one of a UE ID, an internal group ID, and configuration-related parameters.

In step 9a, the NEF 560 may request the configuration related to traffic, for monitoring, from the NFs of the SMF, PCF, and TSCTSF for each UE identified in step 8a and receive a response thereto. According to an embodiment, the request and response messages may include at least one of the UE ID, the PDU session ID, the data network name (DNN)/single network slice selection assistance information (S-NSSAI), the internal group ID, and configuration-related parameters.

The NEF 560 may perform aggregation based on the aggregation condition.

In step 10, the NEF 560 may aggregate responses according to the data processing (or collection) condition of the aggregation condition and may transmit a monitoring response to the AF 570 based on the transfer condition of the aggregation condition. According to an embodiment, the monitoring response may include at least one of External-Group ID, transaction ID, dynamic/static Indication, and aggregation condition. According to an embodiment, the monitoring response may be for a group and may be a collection of responses for each individual UE. According to an embodiment, the monitoring response is for monitoring for each UE, and may be a collection of several responses for individual UEs.

In step 11, the NF of the AMF/PCF/TSCTSF 520 may send an event notify message related to the UE 500 to the NEF 560 when an event occurs that matches a UE-related monitoring request. According to embodiments, the event notify message may include at least one of the UE ID, the internal group ID, and the event ID.

In step 11a, the NF of the SMF/PCF/TSCTSF 530 may send an event notify message related to the UE 500 to the NEF 560 when an event occurs that matches a traffic-related monitoring request. According to embodiments, the event notify message may include at least one of the UE ID, the internal group ID, and the event ID.

The NEF 560 may perform aggregation based on the aggregation condition.

In step 12, the NEF 560 may aggregate monitored events according to the data processing (or collection) condition of the aggregation condition and may transmit a monitoring notify to the AF 570 based on the transfer condition of the aggregation condition. According to an embodiment, the monitoring notify may include at least one of External-Group ID, transaction ID, event ID, UE ID, dynamic/static Indication, and aggregation condition. According to an embodiment, the monitoring notify may be for group monitoring and may be a collection of events for each individual UE. According to an embodiment, the monitoring notify is for monitoring for each UE, and may be a collection of events for individual UEs.

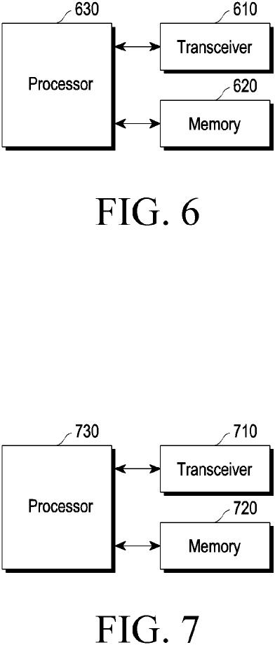

FIG. 6 illustrates a configuration of a UE according to an embodiment of the present disclosure.

As shown in FIG. 6, a UE of the present disclosure may include a transceiver 610, a memory 620, and a processor 630. The processor 630, transceiver 610, and memory 620 of the UE may operate according to the above-described communication methods by the UE. However, the components of the UE are not limited thereto. For example, the UE may include more or fewer components than the above-described components. The processor 630, the transceiver 610, and the memory 620 may be implemented in the form of a single chip.

The transceiver 610 collectively refers to the transmitter of the UE and the receiver of the UE and may transmit and receive signals to/from the base station or network entity. The signals transmitted/received with the base station may include control information and data. To that end, the transceiver 610 may include a radio frequency (RF) transmitter for frequency-up converting and amplifying signals transmitted and an RF receiver for low-noise amplifying signals received and frequency-down converting the frequency of the received signals. However, this is merely an example of the transceiver 610, and the components of the transceiver 610 are not limited to the RF transmitter and the RF receiver.

Further, the transceiver 610 may include a wired/wireless transceiver and may include various components for transmitting/receiving signals.

The transceiver 610 may receive signals via a radio channel, output the signals to the processor 630, and transmit signals output from the processor 630 via a radio channel.

Further, the transceiver 610 may receive the communication signal and output it to the processor and transmit the signal output from the processor to the network entity through the wired/wireless network.

The memory 620 may store programs and data necessary for the operation of the UE. The memory 620 may store control information or data that is included in the signal obtained by the UE. The memory 620 may include a storage medium, such as ROM, RAM, hard disk, CD-ROM, and DVD, or a combination of storage media.

The processor 630 may control a series of processes for the UE to be able to operate according to the above-described embodiments. The processor 630 may include at least one processor. For example, the processor 630 may include a communication processor (CP) that performs control for communication and an application processor (AP) that controls an upper layer, such as an application program.

FIG. 7 illustrates a configuration of a network entity according to an embodiment of the present disclosure.

As shown in FIG. 7, a network entity of the present disclosure may include a transceiver 710, a memory 720, and a processor 730. The processor 730, transceiver 710, and memory 720 of the network entity may operate according to the above-described communication methods by the network entity. However, the components of the network entity are not limited thereto. For example, the network entity may include more or fewer components than the above-described components. The processor 730, the transceiver 710, and the memory 720 may be implemented in the form of a single chip.

The network entity may be implemented as one of the above-described (R)AN, AMF/PCF/TSCTSF, SMF/PCF/TSCTSF, UDM, UDR, NEF, and AF.

The transceiver 710 collectively refers to the receiver of the network entity and the transmitter of the network entity and may transmit and receive signals to/from a UE or another network entity. In this case, the signals transmitted/received with the base station may include control information and data. To that end, the transceiver 710 may include a radio frequency (RF) transmitter for frequency-up converting and amplifying signals transmitted and an RF receiver for low-noise amplifying signals received and frequency-down converting the frequency of the received signals. However, this is merely an example of the transceiver 710, and the components of the transceiver 710 are not limited to the RF transmitter and the RF receiver. The transceiver 710 may include a wired/wireless transceiver and may include various components for transmitting/receiving signals.

Further, the transceiver 710 may receive signals via a communication channel (e.g., a radio channel), output the signals to the processor 730, and transmit signals output from the processor 730 via a radio channel.

Further, the transceiver 710 may receive the communication signal and output it to the processor and transmit the signal output from the processor to the UE or network entity through the wired/wireless network.

The memory 720 may store programs and data necessary for the operation of the network entity. Further, the memory 720 may store control information or data that is included in the signal obtained by the network entity. The memory 720 may include a storage medium, such as ROM, RAM, hard disk, CD-ROM, and DVD, or a combination of storage media.

The processor 730 may control a series of processes for the network entity to be able to operate according to the above-described embodiments. The processor 730 may include at least one processor. The methods according to the embodiments described in the specification or claims of the present disclosure may be implemented in hardware, software, or a combination of hardware and software.

The methods according to the embodiments described in the specification or claims of the present disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the present disclosure.

The programs (software modules or software) may be stored in random access memories, non-volatile memories including flash memories, read only memories (ROMs), electrically erasable programmable read-only memories (EEPROMs), magnetic disc storage devices, compact-disc ROMs, digital versatile discs DVDs), or other types of optical storage devices, or magnetic cassettes. Or the programs may be stored in a memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the present disclosure via an external port. A separate storage device over the communication network may be connected to the device that performs embodiments of the present disclosure.

In the above-described specific embodiments, the components included in the present disclosure are represented in singular or plural forms depending on specific embodiments provided. However, the singular or plural forms are selected to be adequate for contexts suggested for ease of description, and the present disclosure is not limited to singular or plural components. As used herein, the singular forms “a,” “an,” and “the” are intended to include the plural forms as well, unless the context clearly indicates otherwise.

Although specific embodiments of the present disclosure have been described above, various changes may be made thereto without departing from the scope of the present disclosure. Thus, the scope of the present disclosure should not be limited to the above-described embodiments, and should rather be defined by the following claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed:

1. A method for operating a network exposure function (NEF) in a wireless communication system, the method comprising:
receiving, from an application function (AF), a first message for a group of user equipments (UEs) identified by an external group identifier (ID), the first message including the external group ID;
transmitting, to a unified data management (UDM), a second message for requesting service authorization for the group of UEs based on the external group ID; and
transmitting, to the AF, a third message corresponding to the first message.

2. The method of claim 1, further comprising:
mapping the external group ID into an internal group ID used inside a network.

3. The method of claim 2, further comprising:
performing aggregation on a response or reporting based on aggregation condition and the internal group ID,
wherein the aggregation condition includes a first condition for data transmission and a second condition for an event.

4. The method of claim 3, wherein the first condition and the second condition each are set for each group or each UE.

5. The method of claim 3, wherein the first condition includes at least one of tracking area (TA) access information, registration area (RA) access information, period information, guard time information, and event count information, and
wherein the second condition includes at least one of a number of arrivals at the event, a maximum value of arrivals at the event, and event information.

6. The method of claim 1, further comprising:
receiving, from the UDM, information for a member change in the group.

7. The method of claim 1, wherein the first message is related to group provisioning or group monitoring.

8. The method of claim 1, wherein the first message includes an indicator indicating whether a configuration included in the first message continues to apply to a changed member when a group member is changed, and
wherein if the indicator is a first value (dynamic), the configuration included in the first message continues to apply to the changed member, and if the indicator is a second value (static), the configuration included in the first message does not apply to the changed member.

9. A method for operating an application function (AF) in a wireless communication system, the method comprising:
transmitting, to a network exposure function (NEF), a first message for a group of user equipments (UEs) identified by an external group identifier (ID), the first message including the external group ID; and
receiving from the NEF, a second message corresponding to the first message,
wherein service authorization for the group of UEs is based on the external group ID.

10. The method of claim 9, wherein the external group ID is mapped into an internal group ID used inside a network.

11. The method of claim 10, wherein aggregation on a response or reporting is performed based on aggregation condition and the internal group ID, and
wherein the aggregation condition includes a first condition for data transmission and a second condition for an event.

12. The method of claim 11, wherein the first condition and the second condition each are set for each group or each UE,
wherein the first condition includes at least one of tracking area (TA) access information, registration area (RA) access information, period information, guard time information, and event count information, and
wherein the second condition includes at least one of a number of arrivals at the event, a maximum value of arrivals at the event, and event information.

13. The method of claim 11, wherein the first message includes an indicator indicating whether a configuration included in the first message continues to apply to a changed member when a member is changed, and
wherein if the indicator is a first value (dynamic), the configuration included in the first message continues to apply to the changed member, and if the indicator is a second value (static), the configuration included in the first message does not apply to the changed member.

14. A network exposure function (NEF) in a wireless communication system, comprising:
a transceiver; and
a processor configured to control to:
receive, from an application function (AF), a first message for a group of user equipments (UEs) identified by an external group identifier (ID), the first message including the external group ID,
transmit, to a unified data management (UDM), a second message for requesting service authorization for the group of UEs based on the external group ID, and
transmit, to the AF, a third message corresponding to the first message.

15. The NEF of claim 14, wherein the processor configured to control to:
map the external group ID into an internal group ID used inside a network.

16. The NEF of claim 15, wherein the processor configured to control to:
perform aggregation on a response or reporting based on the aggregation condition and the internal group ID,
wherein the aggregation condition includes a first condition for data transmission and a second condition for an event.

17. The NEF of claim 16, wherein the first condition and the second condition each are set for each group or each UE.

18. The NEF of claim 16, wherein the first condition includes at least one of tracking area (TA) access information, registration area (RA) access information, period information, guard time information, and event count information, and
wherein the second condition includes at least one of a number of arrivals at the event, a maximum value of arrivals at the event, and event information.

19. An application function (AF) in a wireless communication system, comprising:
a transceiver; and
a processor configured to control to:
transmit, to a network exposure function (NEF), a first message for a group of user equipments (UEs) identified by an external group identifier (ID), the first message including the external group ID, and
receive, from the NEF, a second message corresponding to the first message, wherein service authorization for the group of UEs is based on the external group ID.

20. The AF of claim 19, wherein the external group ID is mapped into an internal group ID used inside a network.
